(19) United States
(12) Patent Application Publication
(10) Pub. No.: US 2019/0297902 A1
(43) Pub. Date: Oct. 3, 2019

(54) BISCUIT, METHOD AND PRODUCTION PLANT FOR MANUFACTURING A BISCUIT

(71) Applicant: GRIESSON - DE BEUKELAER GMBH & CO. KG, Polch (DE)

(72) Inventors: Fuad Hajji, Koblenz (DE); Thomas Obermeier, Kobern Gondorf (DE); Jutta Dyks, Mayen (DE)

(21) Appl. No.: 16/365,756

(22) Filed: Mar. 27, 2019

(30) Foreign Application Priority Data
Mar. 29, 2018 (EP) 18165176.1

(51) Int. Cl. A21D 13/24; A21D 13/80; A21C 15/00

(52) U.S. Cl. CPC A21D 13/24; A21C 15/002; A21D 13/80

(57) ABSTRACT

Provided is a method for preparing a biscuit including at least one edible piece good on at least a portion of a rough surface of a biscuit preform, the method including at least one baking phase and one cooling phase, following the baking phase, of the biscuit preform. The embodiments further relate to a biscuit with at least one edible piece good, which is fixed on at least a portion of a rough surface of a biscuit preform, wherein the binding agent is not visually perceptible for a consumer of the biscuit. The embodiments also relate to a production plant for preparing a biscuit by a method.

### CROSS-REFERENCE TO RELATED APPLICATION

This application claims priority to European Application No. 18165176.1, having a filing date of Mar. 29, 2018, the entire contents of which are hereby incorporated by reference

### FIELD OF TECHNOLOGY

The following relates to a method for preparing a biscuit comprising at least one edible piece good on at least a portion of a rough surface of a biscuit preform. The following furthermore relates to a biscuit comprising at least one edible piece good that is fixed to at least a portion of a rough surface of a biscuit preform by a binding agent. The following in addition relates to a production plant for preparing a biscuit by a method according to embodiments of the invention.

### BACKGROUND

Various methods for fixing a piece good to baked goods are known.

For example, a cake glaze is known from the patent specification U.S. Pat. No. 3,343,965, which glaze is applied to a dough prior to baking and may contain fruit or nut pieces. A disadvantage in this case is that the fruit or nut pieces are exposed to the baking process, because of which the appearance and/or taste of said pieces may undergo negative change. Furthermore, it is not possible to use a piece good that is destroyed by the baking process, for example because said good melts; it is not possible to use a piece good containing chocolate or caramel. Furthermore, according to U.S. Pat. No. 3,343,959 the fruit or nut pieces are enclosed by the glaze, which can result in a disadvantageous “artificial” appearance of the fruit or nut pieces.

The patent specification U.S. Pat. No. 4,913,919 discloses a coating of an aqueous suspension, containing maltodextrin and starch particles, for food products. The coating can be used to fix an edible piece good to a food product, for example to a biscuit. The appearance and the gas or moisture permeability of the coating can be varied by means of adjusting the ratio of maltodextrin to starch particles. The suspension can be applied before or after baking of the food product. If the suspension is applied after baking, said suspension is heated for drying and hardening, typically for 2 to 10 minutes at 177° C. to 204° C. Here, too, this heat treatment may damage or destroy the piece good.

A method is known from the patent application DE3923596A1, in which baking preforms, optionally provided with a bonding agent, are brought into contact, prior to baking, with a for example granular topping medium. The disadvantage results here, too, that the topping medium is heated.

The patent specification U.S. Pat. No. 5,532,010 discloses coated dog biscuits and a method for the preparation thereof. The coating contains meat pieces and is applied to the baked dog biscuits, for example by means of dipping, and then dried at 52° C. to 149° C. The disadvantage results here, too, that the piece good is enclosed by the coating and heated.

The patent application EP1483969A1 describes a cracker comprising a topping, in small pieces, on a binder layer, and a preparation method therefor. After the binder layer and the topping have been applied to the cooked cracker, said cracker undergoes heat treatment, at 100° C. to 120° C., for 20 to 60 minutes, for drying. Said heat treatment may damage or destroy the topping.

A method for preparing a baked good is known from the patent application DE102007021583A1, in which method a binding mixture and an additional object are poured into a receiving depression of the dough piece prior to baking the dough piece. A disadvantage of this method is that a receiving depression must be provided to position the binding mixture and the additional object, with the result that the method can be applied only to a limited selection of baked goods.

The patent application US20100028497A1 discloses a method for preparing an extruded food product, wherein an edible adhesive and surface inclusions (e.g. grain kernels, fruit pieces or cheese) are applied to an expanded dough strip, before the dough strip is cut into pieces, dried and roasted (e.g. at 200° C. to 250° C.). Said heat treatment may damage or destroy the surface inclusions.

The patent application DE102011108562A1 describes a method for preparing a confectionery product, wherein a binding agent is applied to a long-life baked good, and a mass comprising chocolate, or a chocolate-flavored icing is applied to said binding agent. The chocolate may contain cereals. Here, too, the disadvantage results that the cereals are enclosed by the mixture and are thus not visible to a consumer.

### SUMMARY

An aspect relates to creating a versatile and cost-effective method, by which different edible piece goods can be fixed to a biscuit preform without the sensory perception, in particular the appearance, the taste, the texture or the odor, of the piece good being distorted. The embodiments of the invention provide a biscuit that is simple to prepare and to handle and that comprises a piece good which is fixed to the surface of said biscuit and is not distorted with respect to sensory perception. The embodiments also provide an efficient production plant for preparing a biscuit by means of a method according to embodiments of the invention.

A method according to embodiments of the invention is used for preparing a biscuit comprising at least one edible piece good on at least a portion of a rough surface of the biscuit and comprises at least one baking phase and a cooling phase, following the baking phase, of a biscuit preform. During the cooling phase, the temperature of the biscuit preform drops, from a baking temperature and/or to an ambient temperature of the biscuit preform.

According to embodiments of the invention, the term “biscuit” is understood to mean a pastry, in particular a cookie, in the form of a long-life baked good having a long storage life, in particular of a crumbly consistency and of a hardtack dough or a shortbread dough. Foamed or expanded baked goods, such as dry flat bread, are not covered by the use according to embodiments of the invention of the term “biscuit”. According to embodiments of the invention, the biscuit comprises a rough upper surface, wherein in particular a roughness of the surface may be comparable with a spatial extent of the piece good, for example in a range of from a tenth to ten times, from half to twice, the extent. An example of a biscuit according to embodiments of the invention is a cookie. A rough upper surface advantageously results in an enlarged surface of the biscuit, which may lead to an improved haptic and/or gustatory perception of the biscuit by a consumer, when eating the biscuit. The piece good can advantageously be embedded in depressions in the rough surface at least in part, and thus be protected from environmental influences, for example mechanical wear by means of a composite film of packaging, after production.

A “piece good” within the meaning of embodiments of the invention is a solid having a spatial extent that is significantly smaller than a spatial extent of the biscuit, for example less than a fifth, less than a tenth, thereof. At the same time, the spatial extent of the piece good is sufficiently large for a consumer of the biscuit to be able to visually and/or haptically identify an individual piece good, when eating the biscuit. The spatial extent is for example in a range of from 1 mm to 25 mm, in a range of from 5 mm to 10 mm. As a result, the piece good is advantageously pourable without problem in cost-effective industrial production. A sensory perception, in particular an appearance, a texture, an odor, a taste and/or a feeling during eating, of the biscuit can advantageously be varied by means of the piece good. The piece good can be provided as a single ingredient, for example as a chemically pure substance, or as a mixed ingredient, for example as a mixture of a plurality of pure substances. The use of a single ingredient is advantageous in that characteristics of the biscuit, for example taste or mouthfeel during eating, can be adjusted particularly precisely.

A method according to embodiments of the invention comprises at least the following steps, carried out in succession in the stated order:
a. baking the biscuit preform, from a dough preform or dough piece, during the baking phase;
b. depositing the binding agent, during a deposition phase, at least on the portion, and/or coating a surface of the piece good with the binding agent;
c. applying the piece good, during an application phase, at least to the portion, and
d. curing the binding agent during a curing phase.

Selecting different piece goods and/or different application of the piece goods advantageously makes it possible to prepare a wide range of different biscuits, individualized for a customer, from biscuit preforms of the same type. The dough preform, dough piece or biscuit preform may be premade, in particular prepared using a standard recipe. Using a uniform preform is advantageous in that time-consuming and expensive retooling of a preparation facility is minimized or is even omitted entirely. As a result, the productivity and efficiency of the production increases, followed by an improvement in competitiveness. The biscuit preform can be prepared within the context of the method according to embodiments of the invention or may enter the method premade, from an external supplier.

Within the meaning of embodiments of the invention, the term “baking” includes both thorough baking of a dough preform or dough piece, and post-baking, crisping or re-baking a pre-baked biscuit preform. What is essential for “baking” within the meaning of embodiments of the invention is that at least the upper surface of the biscuit preform is heated in the process, prior to the at least one piece good being applied, at least up to a temperature at which the binding agent can adhere to the biscuit and/or to the piece good, and is advantageously melted thereon. At the same time, the upper surface should not be so hot that the binding agent becomes too runny to remain on the biscuit preform until the piece good is applied or is permanently optically or chemically changed upon contact with the upper surface, for example develops an unpleasant taste or an unattractive appearance. Tests have revealed particularly suitable temperature ranges therefore of from 28° C. to 120° C., particularly advantageously from 30° C. to 80° C.

The binding agent may for example be a flowable suspension or an aqueous solution, of a sugar, such as glucose syrup, for example in water. Deposition of the binding agent, and/or coating of a surface of the piece good with the binding agent, can advantageously ensure that the piece good adheres reliably to the biscuit preform, to a rough surface, when the piece good is applied only after baking. This results in simple handling of the biscuit; the biscuit can be easily transported and packaged without the piece good detaching from the biscuit preform. The advantage of the coating, which may take place locally and/or temporally independently of the further method steps, is that no binding agent remains on regions of the biscuit preform not provided with the piece good, and therefore a particularly natural appearance of the biscuit results. The coated piece good can be produced independently of the biscuit preform.

The curing achieves stable fixing of the piece good to the biscuit preform in a short time. The curing comprises complete drying and/or setting of the binding agent.

Advantageously, the cooling phase may comprise the deposition phase, the application phase and the curing phase, and/or a temperature of the biscuit preform can
e. be below a maximum deposition temperature and above a minimum deposition temperature during the deposition phase, and/or
f be below a maximum application temperature and above a minimum application temperature during the application phase.

Since the cooling phase comprises the deposition phase, the application phase and the curing phase, i.e. the deposition, the application and the curing thus take place during cooling of the biscuit preform after baking, which cooling is required in any case, a particularly time-efficient method results. Advantageously, the residual heat remaining in the biscuit preform after baking is used to ensure that the temperature of the biscuit preform is above a minimum deposition temperature during the deposition phase and/or above a minimum application temperature during the application phase. It is thus not necessary to re-heat the biscuit preform, which would require additional time, energy and heating apparatuses. Furthermore, omitting re-heating prevents formation of substances in the biscuit preform and/or piece good that are harmful to health, for example acrylamide. Moreover, an application temperature can advantageously be selected such that the coating of a coated piece good melts on only in a region of contact with the biscuit preform and is not thermally degraded, for example changed in color, on a side remote from the biscuit preform and visible to the consumer. Consequently, in a particularly advantageous embodiment of the method, no heating of the biscuit preform is affected after the cooling phase.

An advantage of the method according to embodiments of the invention is that a plurality of semi-finished goods, for example, a biscuit preform and a piece good, coated with a binding agent, can be combined in a simple and efficient manner to form one product. Combining different semi-finished goods makes it possible to prepare a large variety of different products, in a short time, using simple means, without making changes to a production plant.

The maximum deposition temperature is for example a binding agent degradation temperature (for example above 208° C. for maltodextrin), above which the binding agent is thermally degraded. The minimum deposition temperature is for example a setting temperature, below which the binding agent sets. If the temperature of the biscuit preform during the deposition phase is between the maximum and the minimum deposition temperature, this ensures that the binding agent is not thermally degraded and on the other hand is also provided in a fluid form and/or a form that is adhesive for the piece good, such that said binding agent can wet the biscuit preform and/or the piece good and act as an adhesion promoter between the biscuit preform and the piece good.

The maximum application temperature is for example a piece good degradation temperature, above which the piece good is thermally degraded, changed in terms of its appearance and/or taste. The maximum application temperature may be a melting temperature or denaturing temperature of the piece good. For a caramel piece good, a maximum application temperature is for example at a melting temperature of caramel, in the range of from 48° C. to 65° C. The minimum application temperature is for example a setting temperature, below which the binding agent sets. If the temperature of the biscuit preform during the application phase is between the maximum and the minimum application temperature, this ensures that the piece good is not thermally degraded and that the binding agent is in a suitable state for fixing the piece good to the biscuit preform.

A concept according to embodiments of the invention is that of lengthening a setting time of the binding agent on the biscuit preform into the application phase of the piece good, by means of the biscuit preform functioning, in the cooling phase, as a heat reservoir for the deposited binding agent. The longer the setting time can be lengthened in this manner, the simpler and more reliable, in terms of production technology, is the step of applying the piece good. The temperature in the application phase can be set such that a temperature range can be adjusted, over a period that is sufficiently long for loading the portion of the biscuit preform surface with the piece good, such that the binding agent is adhesive and the piece good is not damaged. For example, in the case of a piece good formed as chocolate, it is possible to prevent an oily sheen or a milky surface from developing. Changes to the piece good in terms of color, shape, texture or taste, which could occur owing to the piece good being heated too much, are prevented. As a result, in particular also a heat-sensitive piece good, which for example melts in the presence of heat, such as in particular chocolate, changes color, such as in particular chocolate beans (e.g. Smarties), caramel or jellied fruit pieces, and/or changes in taste, such as in particular popcorn, puffed quinoa seeds or marshmallows, can be used, resulting in high versatility of the method.

In a particularly advantageous embodiment of the method, after the piece good has been applied to an in particular premade biscuit preform, the piece good is not heated above a phase transition temperature, for example a melting temperature or a denaturing temperature, of the piece good, in particular is not heated above 50° C., in particular 30° C. Particularly advantageously, the piece good is not heated after the application.

The method may comprise adjustment of at least one physicochemical property of the binding agent that is also in particular relevant for the suitability of the binding agent as an adhesion promoter between the biscuit preform and the piece good, in particular a pH value, a viscosity, a temperature and/or a Brix value, and also further properties such as an aroma. The adjustment can for example ensure that a surface of the biscuit preform and/or of the piece good is wetted uniformly, such that good fixing of the piece good to the biscuit preform is achieved, without heating of the biscuit preform and/or piece good. Furthermore, an adhesion of the binding agent to and/or a capacity of the binding agent to be deposited on the biscuit preform and/or the piece good, an appearance of the binding agent, and/or a possibility of selectively removing the binding agent from the biscuit preform and/or the piece good, can advantageously be adjusted. A possibility of selectively removing the binding agent may be for example drawing the binding agent into the biscuit preform and/or the piece good, and or blowing off and/or suctioning out the binding agent. Drawing in the binding agent is advantageous if the binding agent contains a humectant, for example sorbitol or glycerol, for the biscuit, since it is thus possible to adjust a moisture content of the biscuit, by means of the binding agent, without further method steps.

The adjustment can take place for example by means of adapting a temperature of the binding agent and/or by adding at least one solvent and/or at least one ingredient, a humectant such as sorbitol or glycerol, to the binding agent, while stirring the binding agent.

At the time of deposition, the binding agent may have a pH value of between 4 and 9, in particular between 5 and 8, for example 7. An approximately neutral pH value of this kind prevents the sensory perception of the piece good from changing due to contact with the binding agent. For example, a highly acidic pH value could lead to discoloration of the piece good.

At the time of deposition, the binding agent may have a Brix value of over 50° Bx, in particular between 50° Bx and 90° Bx. In the case of an aqueous solution or suspension, in particular of a sugar, a high Brix value corresponds to a low water content in relation to substances dissolved or suspended therein. A low water content in the binding agent leads to a low water content in the biscuit, with the result that said biscuit has a longer shelf life and is protected from mound formation. However, tests have shown that a Brix value of over 90° Bx brings about a viscosity of the binding agent that is too great for the deposition. Therefore, the pH and the Brix value of the binding agent are particularly relevant for maintaining the quality of the piece good and of the biscuit.

According to embodiments of the invention, the deposition of the binding agent can take place prior to, during and/or after the application of the piece good. If the deposition of the binding agent takes place prior to and/or during the application of the piece good, this results in the advantages that a contact surface between the piece good and the biscuit preform can be wetted by the binding agent for particularly good fixing of the piece good to the biscuit preform. If the deposition takes place prior to the application, this can prevent the piece good from being covered, which could lead to a disadvantageous change in the appearance of said piece good. If the deposition takes place during and/or after the application, the piece good can be encased by the binding agent for particularly good fixing.

The deposition of the binding agent on the premade biscuit preform can take place after baking, before the biscuit preform has cooled from baking to an ambient temperature. Since the deposition takes place after the baking, the application of the piece good can take place during the deposition and/or shortly thereafter, with the result that the binding agent is not yet set for example during the deposition, and therefore good fixing of the piece good to the binding agent takes place. If the deposition takes place before the biscuit preform has cooled, for example at a temperature of the biscuit preform of from 30° C. to 70° C., this can advantageously delay setting of the binding agent.

The deposition of the binding agent can take place by means of spreading on, using a profiled spreading tool. The spreading on can uniformly apply a binding agent having a viscosity that is of such a high level that said binding agent does not flow out of the portion before the piece good is applied, which is advantageous for example for fixing a relatively large piece good because said piece good can sink into said binding agent in part.

The deposition of the binding agent can take place by means of spraying, at an angle of between 10° and 80°, particularly between 30° and 60°, onto a contact surface of the biscuit preform, from a plurality of directions, by means of a mask and/or using at least one directable nozzle. The spraying on, in the embodiments mentioned, advantageously allows for uniform and quick distribution of the binding agent, on a rough surface. In a particularly advantageous embodiment, the spraying on comprises ultrasonic atomization of the binding agent, as a result of which it is possible to achieve a particularly fine spray mist and thus particularly uniformly and finely metered wetting of the biscuit preform by the binding agent. Furthermore, ultrasonic atomization makes it possible to ensure that a deposition device does not become clogged, even at a low flow rate and/or during intermittent operation.

The coating of the piece good with the binding agent can take place for example by means of dipping the piece good in the binding agent and/or by means of spraying the binding agent onto the piece good, in particular by means of ultrasonic atomization.

The method may comprise removing binding agent that is not located on a contact surface between the piece good and the upper surface of the biscuit preform, following application. The removal may take place for example by means of blowing off or suctioning the binding agent, and/or by drawing the binding agent into the biscuit. The removal advantageously gives the biscuit, loaded with the piece good, a particularly natural, qualitatively high-grade appearance.

The method may comprise detaching an inadequately bonded piece good from the biscuit preform, for example by shaking off, blowing off and/or suctioning out the inadequately bonded piece good. The detachment advantageously prevents an inadequately bonded piece good from detaching later, for example when the biscuit is packaged, transported or eaten. As a result, the biscuit creates a particularly high-quality impression for a consumer.

The method may comprise returning the detached piece good and applying the detached piece good to a further biscuit preform, in particular by means of a return apparatus which may comprise a conveyor belt for example. The returning advantageously allows for particularly efficient use of the piece good.

According to embodiments of the invention, the deposition of the binding agent makes it possible for a sensory perception, in particular a taste, a sweetness and/or an aroma, and/or a consistency, a moisture content, of the biscuit to be adjusted. For example, a solvent contained in the binding agent, in particular water, and/or a humectant, in particular sorbitol or glycerol, can penetrate the biscuit preform to create a soft consistency of the biscuit. It is thus possible, for example, to adjust a water content of the biscuit, to a value of between 3 and 5% for a cookie or between 5 and 9% for a soft cookie. Furthermore, for example a flavoring contained in the binding agent, in particular a sweetener, can create a stronger taste for a consumer than if the same amount of flavoring were contained in a biscuit dough from which the biscuit preform is prepared, because the flavoring contained in the binding agent is located on the surface of the biscuit and thus is directly accessible when eaten. The flavoring is used particularly efficiently in this manner. Moreover, the binding agent may also contain flavorings that cannot be used in the biscuit dough, for example owing to interactions with other ingredients of the biscuit dough or because a temperature resistance of the flavorings is not sufficient for the baking of the biscuit preform. A particularly wide variety of biscuits can be prepared by the method by means of the adjustment of the taste and/or the consistency.

The deposition of the binding agent and/or the application of the piece good can take place in the form of a pattern, an image, a logo and/or a series of characters. As a result, a particularly wide variety of designs of biscuits can be prepared by means of the method. The deposition and/or application can take place for example through a mask and/or using at least one directable nozzle.

The pattern may be two-dimensional, i.e. consisting of exactly one, optionally broken, layer of the piece good, or three-dimensional, i.e. consisting of a plurality of, optionally likewise broken, layers of the piece good. In the case of a three-dimensional pattern, a plurality of different piece goods, for example one per layer, can be used. If a plurality of layers of the piece good are applied, a surface of the previous layer in each case can be post-heated and/or further deposition of binding agent can take place, prior to a further layer being applied. The post-heating, for example using at least one infrared radiation, and/or the further deposition, can advantageously ensure stable adhesion of the piece good of the further layer to the piece good of the previous layer.

The deposition of the binding agent and/or the application of the piece good can leave free an edge region of the biscuit preform. As a result, a consumer can particularly simply grip the biscuit in the edge region without detaching the piece good from the biscuit.

The application of the piece good can take place on a surface that extends beyond the portion. This “random” application makes it possible for the application to take place using particularly simple means and particularly quickly. Any piece good appearing on the biscuit preform outside the portion provided with the binding agent can optionally be subsequently removed again.

The application of the piece good may for example comprise scattering the piece good onto the biscuit preform. Scattering has the advantages of being technically simple to implement and suitable for a plurality of different piece goods.

The application of the piece good may comprise temperature control of the piece good, when using a self-adhesive, edible piece good. The piece good can be temperature-controlled to a temperature at which it is pourable, i.e. in particular not sticky, and on the other hand, adheres to the biscuit preform via the binding agent present on the piece good and/or on the biscuit preform. The residual heat still contained in the biscuit preform from the baking process can heat the piece good upon contact with the biscuit preform to above the previously adjusted temperature of the piece good, and thus allow for good adhesion. As a result, according to embodiments of the invention the piece good can be temperature-controlled to a lower temperature, for example to approximately 30° C. instead of over 60° C., than in generic methods, such that the piece good remains pourable until it makes contact with the biscuit preform, also when coated with binding agent. Furthermore, a lower temperature control maintains color, consistency and taste of the piece good.

The curing of the binding agent may comprise controlled cooling of the biscuit. The cooling may for example take place by means of contact of the biscuit with a temperature-controlled airflow and/or a temperature-controlled surface. The cooling advantageously takes place sufficiently slowly that no cracks and/or flaking occurs owing to different thermal expansion coefficients of the biscuit preform, binding agent and/or piece good.

The biscuit according to embodiments of the invention comprises at least one edible piece good that is fixed to at least a portion of a rough upper surface of a biscuit preform by means of a binding agent.

The components of the biscuit can be designed as described in relation to the method according to embodiments of the invention, resulting in the advantages described therein.

In an advantageous embodiment, the binding agent is not visually perceptible for a consumer of the biscuit. Within the meaning of embodiments of the invention, “not visually perceptible” means that a consumer does not perceive the binding agent when consuming the biscuit at a level of attention suitable for the situation. Within the meaning of embodiments of the invention, “suitable for the situation” means that, although the consumer looks at the biscuit prior to eating, in particular also at a short range of for example 30-60 cm and from varying viewing angles, but in the process, he checks only briefly what he is eating, and in particular does not examine the biscuit more thoroughly. This examination usually lasts for less than a second and takes place unconsciously at least in part. The consumer observes the biscuit with his naked eye and without optical aids.

The fact that the binding agent is not visually perceptible results in the advantage of the binding agent being less evident, compared with the biscuit preform and the piece good, in the visual perception, and not being perceived as a distinct component. This leads to an apparently binding agent-free, and thus particularly natural and high-quality appearance of the biscuit. The biscuit is not rendered unsightly by the binding agent, and thus the quality of said biscuit is not reduced.

The binding agent may for example be translucent, transparent, and/or form a matt coating. In this embodiment, the binding agent is advantageously not visually perceptible. A matt coating provides the advantage of also not creating any reflection, even during movement of the biscuit, that would be visually perceptible for a consumer.

The binding agent can comprise a humectant, sorbitol or glycerol.

The binding agent can be arranged only on a contact surface between the piece good and the surface of the biscuit preform, for example because of being selectively applied only there and/or removed outside of the contact surface.

The binding agent can be drawn into the biscuit preform, outside of a contact surface between the piece good and the surface of the biscuit preform.

The binding agent may comprise a hydrocolloid, a polysaccharide, particularly high-amylose starch and/or maltodextrin. High-amylose starch provides the advantage of forming a rigid film in a short time, for example in a few seconds, with the result that secure fixing of the piece good to the biscuit preform can be achieved particularly quickly.

The binding agent may for example comprise a sugar, glucose syrup. A sugar provides the advantages of allowing for stable binding of the piece good to the biscuit preform and of being harmless for use in food.

The biscuit may be preparable, in particular prepared, by means of application of the piece good, and advantageously a deposition of the binding agent, after baking of the biscuit, for example using a method according to embodiments of the invention, resulting in the advantages and possible embodiments described in relation to the method according to embodiments of the invention.

The piece good can be unstable with respect to baking and/or color, and comprise for example popcorn, puffed quinoa seeds, marshmallows, jellied fruit pieces, caramel pieces, chocolate pieces, chocolate sprinkles and/or chocolate beans. In addition, or as an alternative to a piece good that is unstable with respect to baking and/or color, the appearance and/or taste of which piece good is changed by baking, the biscuit may also comprise another piece good such as nut pieces and/or grain kernels.

The biscuit may comprise an edge region that is free of binding agent and/or the piece good, and/or the binding agent and/or the piece good may form a pattern, an image, a logo and/or a series of characters. This results in the advantages described above with respect to the corresponding method features.

A production plant according to embodiments of the invention is designed for preparing a biscuit from a biscuit preform by means of a method according to embodiments of the invention. The production plant comprises at least:
a. a binding agent preparation apparatus for adjusting at least one physical property, selected from a viscosity, a Brix value and a temperature of a binding agent;
b. a deposition apparatus for depositing the binding agent on at least a portion of a rough upper surface of the biscuit preform, and
c. an application apparatus for applying at least one piece good, at least to the portion.

The embodiments comprise the use of a production plant according to embodiments of the invention for performing a method according to embodiments of the invention.

The binding agent preparation apparatus comprises for example a container for receiving the binding agent, a mixing apparatus, for example an agitator, for thoroughly mixing the binding agent, a temperature-control apparatus, comprising for example a heating resistor, for temperature control of the binding agent, and/or a number of metering apparatuses for metering components of the binding agent into the container.

The deposition apparatus may for example comprise a number of in particular directable nozzles for spraying, and/or a number of in particular profiled brushes for spreading the binding agent onto the biscuit preform. The deposition apparatus can advantageously comprise an ultrasonic atomizer for generating a particularly fine binding agent spray mist.

The application apparatus may for example comprise a scattering apparatus for scattering the piece good onto the biscuit preform, and/or a mask for applying the piece good to a defined portion of the biscuit preform.

The production plant may comprise a controller for automatically controlling the deposition apparatus and/or the application apparatus. The controller advantageously comprises a sensor unit for detecting a position and/or type of the biscuit preform. The sensor unit may for example comprise a camera system and an image identifying algorithm for identifying the biscuit preform. The controller can advantageously detect the type and position of a biscuit preform, and thereupon control the deposition apparatus and/or the application apparatus such that the binding agent and/or the piece good is applied primarily on the biscuit preform and not in the surroundings thereof. The binding agent and/or piece good are used particularly efficiently as a result.

The production plant may comprise at least one transport means or transporter for the biscuit preform and/or the biscuit, for example a conveyor belt, for feeding the biscuit preform to different parts of the production plant, and/or a testing facility and/or packaging facility for the biscuit. The transport means or transporter can for example comprise at least one warming portion for keeping the biscuit preform warm following baking. The warming portion may for example comprise a heat insulation means or heat insulation, for example a tunnel of a heat insulating material, for thermally insulating the biscuit preform. The warming portion can advantageously keep the biscuit preform warm, during transport to a deposition apparatus and/or application apparatus, such that the temperature of the biscuit preform upon reaching the deposition apparatus and/or application apparatus is still above a minimum deposition temperature or application temperature. As are result, the residual heat of the biscuit preform can be used efficiently to achieve good adhesion of the piece good to the biscuit preform. In an embodiment that is particularly simple to implement, the warming portion may be formed by a precooling tunnel, known from generic biscuit production, the cooling of which tunnel is deactivated.

The facility may contain at least one discharge apparatus for discharging defective biscuits (e.g. having too low a mass). The discharge apparatus can remove defective biscuits from the production process early on, such that the quality of the biscuits remaining in the production process is increased. The production does not need to be interrupted for this purpose, and nor does an entire batch, containing one defective biscuit, have to be destroyed. In a method according to embodiments of the invention that comprises a plurality of steps following baking of the biscuit preform, there is an increased risk of errors, for example incomplete covering of the biscuit preform with the piece good, occurring, for example during deposition of the binding agent or application of the piece good. Therefore, a discharge apparatus and corresponding discharge are of importance for a method according to embodiments of the invention and a production plant according to embodiments of the invention.

The production plant may comprise at least one removal apparatus for removing excess binding agent and/or for detaching an inadequately bonded piece good from the biscuit preform. The removal apparatus may for example comprise a fan for blowing binding agent and/or a piece good off the biscuit preform, a heating apparatus for vaporizing or subliming binding agent, and/or a shaking apparatus for shaking piece good off the biscuit preform.

The production plant may comprise at least one return apparatus for returning a piece good, detached from a biscuit preform, to the application apparatus, wherein the return apparatus for example comprises a conveyor belt.

The production plant may comprise at least one curing apparatus for curing the binding agent. The curing apparatus may for example comprise a cooling tunnel for controlled cooling of the biscuit.

The production plant may comprise at least one baking chamber for baking, thorough baking, post-baking and/or re-baking a biscuit dough piece or biscuit preform to form the biscuit preform.

### BRIEF DESCRIPTION

Some of the embodiments will be described in detail, with reference to the following figures, wherein like designations denote like members, wherein:

FIG. 1 a schematic view of a method according to embodiments of the invention;

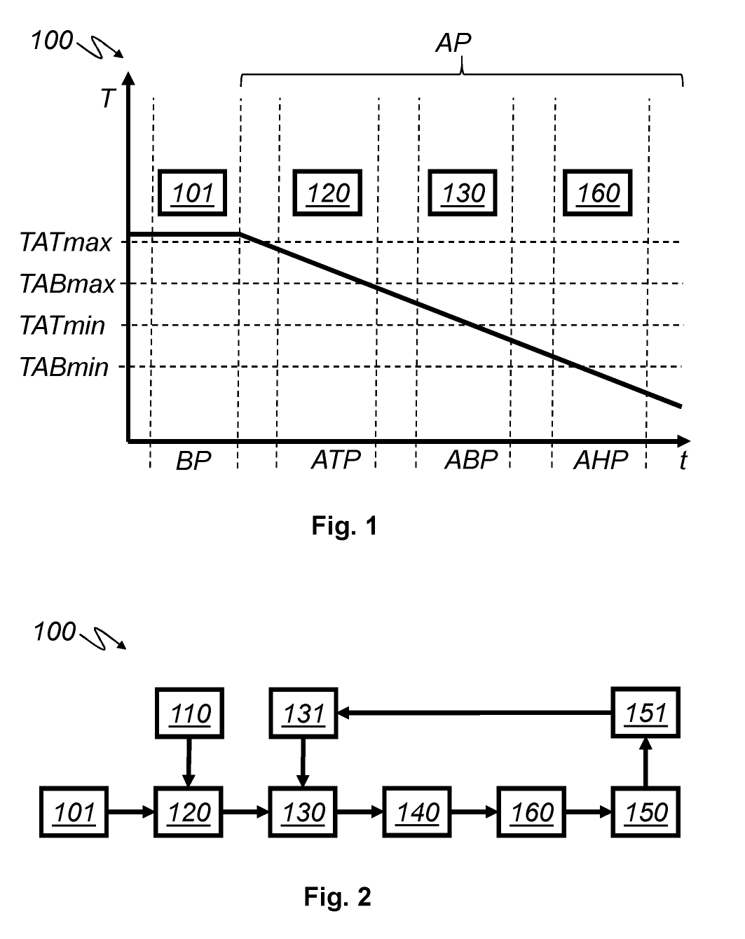

FIG. 2 a schematic view of a further method according to embodiments of the invention;

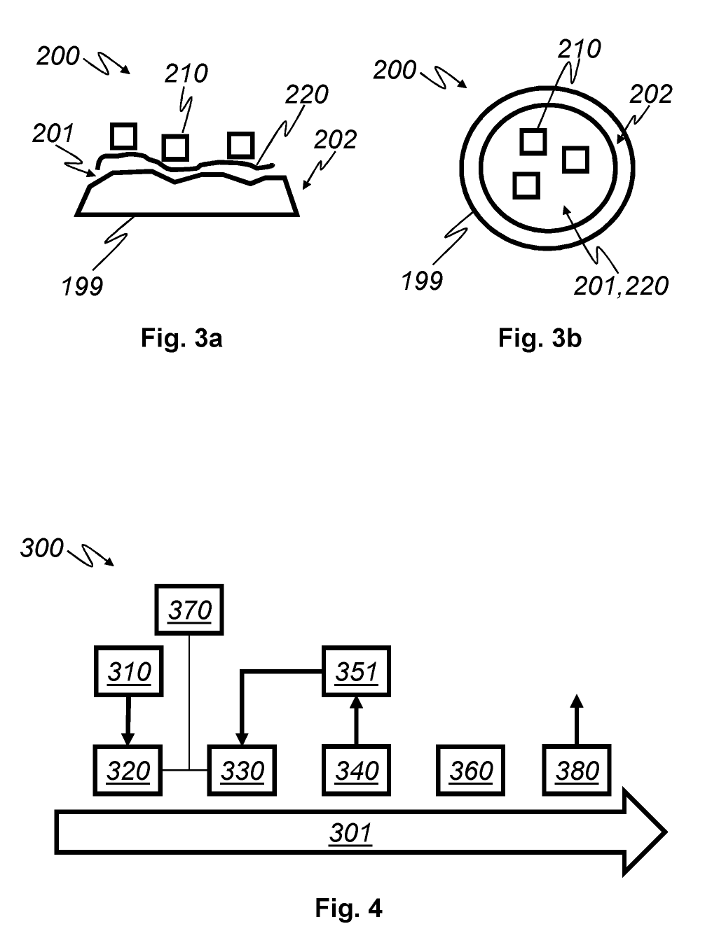

FIG. 3a is a side view of a biscuit according to embodiments of the invention;

FIG. 3b is a top view of a biscuit according to embodiments of the invention; and

FIG. 4 a schematic view of a production plant according to embodiments of the invention;

### DETAILED DESCRIPTION

FIG. 1 is a schematic view of a method 100 according to embodiments of the invention for preparing a biscuit 200 comprising at least one edible piece good 210, for example caramel pieces, on at least a portion 201 of a rough upper surface of a biscuit preform 199, for example of a cookie, wherein the method 100 for example comprises the following steps:
a. baking 101 the biscuit preform 199 during a baking phase BP;
b. depositing 120, for example spraying on, a binding agent 220, for example glucose syrup, during a deposition phase ATP, at least on the portion 201;
c. applying 130, for example scattering on, the piece good 210, during an application phase ABP, at least to the portion 201, and
d. curing 160 the binding agent (220) during a curing phase AHP.

The steps mentioned may for example be carried out in succession, in the order stated.

FIG. 1 shows a curve, by way of example, of a temperature T of the biscuit preform 199, as a function of the time t, during the method 100. The baking phase BP is followed by a cooling phase AP, while the temperature T drops, for example linearly or exponentially. In the example shown, the cooling phase AP comprises the deposition phase ATP, the application phase ABP and the curing phase AHP.

During the deposition phase ATP, the temperature T is advantageously below a maximum deposition temperature TATmax, for example a degradation temperature of the binding agent 220, and above a minimum deposition temperature TATmin, for example a setting temperature of the binding agent 220.

During the application phase ABP, the temperature T is advantageously below a maximum application temperature TABmax, for example a degradation temperature of the piece good 210, and above a minimum application temperature TABmin, for example a setting temperature of the binding agent 220.

The temperature ranges thus defined, for the deposition phase and the application phase, may overlap, as in the example shown, or may be mutually spaced, or identical to one another.

FIG. 2 is a schematic view of a further method 100 according to embodiments of the invention, which may comprise further steps in addition to the steps shown in FIG. 1.

The method 100 may comprise adjustment 110 of at least one physicochemical property of the binding agent 220, for example a viscosity, wherein the adjustment 110 takes place for example by means of adapting a temperature of the binding agent 220, while stirring the binding agent 220. The adjustment 110 advantageously takes place prior to the deposition 120 of the binding agent onto the biscuit preform 199.

The method 100 may comprise removing 140 binding agent 220 that is not located on a contact surface between the piece good 210 and the surface of the biscuit preform 199, following application 130, for example by means of drawing the binding agent 220 into the biscuit preform 199.

The method 100 may comprise detaching 150 an inadequately bonded piece good 210 from the biscuit preform 199, for example by shaking off the inadequately bonded piece good 210. The method 100 may comprise a return 151, for example by means of a conveyor belt, of the detached piece good 210, for application 130 to a further biscuit preform 199.

The application 130 may comprise temperature control 131 of the piece good 210, for example to a temperature at which the piece good 210 does not agglutinate and at which the binding agent 220 can also adhere to the biscuit preform.

FIG. 3 is a schematic side view (FIG. 3a) and plan view (FIG. 3b) of a biscuit 200 according to embodiments of the invention. The biscuit 200 comprises at least one edible piece good 210 (denoted only by way of example), for example caramel pieces. The piece good 210 is fixed to at least a portion 201 of a rough upper surface of a biscuit preform 199, for example of a cookie, by means of a binding agent 220, for example glucose. In this case, the binding agent 220 is advantageously not visually perceptible for a consumer of the biscuit 200, for example because it forms a transparent and matt coating on the biscuit preform 199.

The biscuit 200 may comprise an edge region 202 that is free of the piece good and also free of binding agent.

FIG. 4 is a schematic view of a production plant 300 according to embodiments of the invention for preparing a biscuit 200 from a biscuit preform 199 by means of a method according to embodiments of the invention. The production plant comprises a binding agent preparation apparatus, for example comprising a container for receiving the binding agent, a mixing apparatus for thoroughly mixing the binding agent, and a temperature-control apparatus for temperature control of the binding agent 220, for adjusting 110 at least one physicochemical property of a binding agent 220.

The production plant 300 comprises a deposition apparatus 320, for example comprising a number of nozzles, for spraying the binding agent onto the biscuit preform, for depositing 120 the binding agent 220 on at least a portion 201 of a rough upper surface of the biscuit preform.

The production plant 300 comprises an application apparatus 330, for example comprising a scattering apparatus for scattering the piece good 210 onto the biscuit preform 199, for applying 130 at least one piece good 210 at least to the portion 201.

The production plant 300 may comprise a controller 370, for example comprising a sensor unit for detecting a position and/or type of the biscuit preform 199, for automatically controlling the deposition apparatus 320 and/or the application apparatus 330.

The production plant 300 may comprise a transport means or transporter 301, for example a conveyor belt, for the biscuit 200 and/or the biscuit preform 199.

The production plant 300 may comprise a removal apparatus 340, for example comprising a fan for blowing binding agent 220 and/or a piece good 210 off the biscuit preform 199, for removing 140 excess binding agent 220 and/or detaching 150 an inadequately bonded piece good 210 from the biscuit preform 199.

The production plant 300 may comprise a return apparatus 351, for example comprising a conveyor belt, for returning 151 piece good 210, detached from a biscuit preform 199, to the application apparatus 330, and/or a discharge apparatus 380 for discharging defective biscuits 200.

The production plant 300 may comprise a curing apparatus 360, for example a cooling tunnel, for curing the binding agent 220.

### LIST OF REFERENCE CHARACTERS

100 method
101 baking
110 adjustment
120 deposition
130 application
131 temperature control
140 removal
150 detachment
151 returning
160 curing
199 biscuit preform
200 biscuit
201 portion
202 edge region
210 piece good
220 binding agent
300 production plant
301 transport means or transporter
310 binding agent preparation apparatus
320 deposition apparatus
330 application apparatus
340 removal apparatus
360 curing apparatus
370 controller
380 discharge apparatus
ABP application phase
AHP curing phase
AP cooling phase
ATP deposition phase
BP baking phase
TABmax maximum application temperature
TABmin minimum application temperature
TATmax maximum deposition temperature
TATmin minimum deposition temperature
T temperature
t time

1. A method for preparing a biscuit comprising at least one edible piece good on at least a portion of a rough surface of a biscuit preform, said method comprising at least one baking phase (BP) and one cooling phase (AP), following the baking phase (BP), of the biscuit preform, wherein the method comprises at least the following steps:
a. baking the biscuit preform during the baking phase (BP);
b. deposition a binding agent, during a deposition phase (ATP), at least on the portion;
c. application the piece good, during an application phase (ABP), at least to the portion, and
d. curing the binding agent during a curing phase (AHP),
wherein
the deposition of the binding agent takes place prior to the application of the piece good, and
the deposition phase (ATP), the application phase (ABP) and the curing phase (AHP) are comprised by the cooling phase (AP) and a temperature (T) of the biscuit preform
e. is below a maximum deposition temperature (TATmax) and above a minimum deposition temperature (TATmin) during the deposition phase (ATP), and
f. is below a maximum application temperature (TABmax) and above a minimum application temperature (TABmin) during the application phase (ABP).

2. The method according to claim 1, wherein an adjustment of at least one physicochemical property of the binding agent, having a viscosity, a pH value, a Brix value or a temperature, of a binding agent takes place, wherein the adjustment takes place by adapting a temperature of the binding agent and/or by adding at least one solvent, and/or an ingredient to the binding agent.

3. The method according to claim 1, wherein the deposition of the binding agent takes place at a pH value of the binding agent of between 4 and 9 and/or a Brix value of the binding agent of over 50° Bx.

4. The method according to claim 1, wherein the deposition of the binding agent
a. takes place by spreading using a profiled spreading tool; and/or
b. by spraying at an angle of between 10° and 80° to a contact surface of the biscuit preform, from a plurality of directions, by means of a mask and/or using at least one directable nozzle and/or an ultrasound nozzle.

5. The method according to claim 1, having removing of binding agent that is not located on a contact surface between the piece good and the surface of the biscuit preform, following application by means of blowing-off or suctioning out the binding agent and/or a drawing of the binding agent into the biscuit preform.

6. The method according to claim 1, having detaching an inadequately bonded piece good from the biscuit preform by shaking off, blowing off and/or suctioning out the inadequately bonded piece good, and returning the detached piece good for application to a further biscuit preform.

7. The method according to claim 1, wherein by the deposition of the binding agent, a sensory perception, comprising a taste and/or a consistency of the biscuit is adjusted.

8. The method according to claim 1, wherein
a. the deposition and/or application leaves free an edge region of the biscuit preform and/or
b. the application takes place on to a surface that extends beyond the portion.

9. The method according to claim 1, wherein the application comprises temperature control of the piece good.

10. The method according to claim 1, wherein the curing of the binding agent comprises controlled cooling of the biscuit.

11. A production plant for preparing a biscuit from a biscuit preform by a method according to claim 1, comprising at least
a. a binding agent preparation apparatus for adjusting at least one physicochemical property, selected from a viscosity, a Brix value and a temperature, of a binding agent;
b. a deposition apparatus for depositing the binding agent on at least a portion of a rough upper surface of the biscuit preform;
c. an application apparatus for applying at least one piece good, as a single and/or mixed ingredient, at least to the portion;
d. a controller for automatically controlling the deposition apparatus and the application apparatus;
e. a transporter for the biscuit preform comprising a warming portion for keeping the biscuit preform warm following baking;
f. a curing apparatus for curing the binding agent and
g. a baking chamber for baking a biscuit dough piece to the biscuit preform.

12. The production plant according to claim 11, wherein the controller comprises a sensor unit for detecting a position and/or type of the biscuit preform.

13. The production plant according to claim 11, having at least one discharge apparatus for discharging defective biscuits.

14. The production plant according to claim 11, having at least one removal apparatus for removing excess binding agent and/or detaching an inadequately bonded piece good from the biscuit preform.

15. The production plant according to claim 11, having at least one return apparatus for returning a piece good, detached from a biscuit preform, to the application apparatus.
